(19) United States
(12) Patent Application Publication
(10) Pub. No.: US 2004/0167842 A1
(43) Pub. Date: Aug. 26, 2004

(54) Methods and apparatus for managing asset entitlements

(76) Inventors: Erika B. Klein, Superior, CO (US); Stan D. Shurygailo, Boulder, CO (US); Philip Braum, Golden, CO (US); Francine Slack, Golden, CO (US); Allison P. Aldridge-Saur, Longmont, CO (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/374,022

(22) Filed: Feb. 25, 2003

(51) Int. Cl. G06F 17/60

(52) U.S. Cl. 705/36

(57) ABSTRACT

Disclosed are novel methods and apparatus for provision of efficient, effective, and/or flexible management of asset entitlements. In accordance with an embodiment of the present invention, a method of decoupling an entitlement creation from an asset attachment is disclosed. The method includes: upon a purchase of an entitlement, generating an entitlement entity corresponding to the purchased entitlement; generating an association entity corresponding to the entitlement entity; upon receiving an administrative request to associate the entitlement with an asset, generating an asset entity corresponding to the asset; and associating the asset entity with the entitlement entity.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright© 2003, Sun Microsystems, Inc., All Rights Reserved.

### FIELD OF INVENTION

The present invention generally relates to the field of entitlements. More specifically, an embodiment of the present invention provides for management of asset entitlements.

### BACKGROUND OF INVENTION

As the Internet becomes increasingly a part of everyday life, the number of users utilizing the web to perform commercial transactions (such as e-commerce) is growing exponentially. The always-available services through web pages are contributing to this growth. For example, a user in a different time zone than a service provider does not have to worry about the customer service hours of operation when utilizing a web-based customer service tool. As a result of its many benefits, e-commerce is envisioned to become more commonplace than traditional commerce in the coming years.

Larger companies are also actively participating in the commercial use of the Internet. One problem with today's Internet-based solutions, however, is that creation of an entitlement requires that the entitlement be associated with an asset at the same time. For example, to purchase an entitlement, a purchaser needs to identify an asset prior to finishing the purchase transaction. The entitlement will then be linked to that asset. Such requirements involved in the traditional entitlement creation process can be cumbersome and time-consuming.

Also, the limitations imposed by the traditional entitlement creation systems restrict free commercial transactions by resellers. For example, resellers who are in the business of buying from a seller and selling to a purchaser are not able to utilize entitlements without having to link them to assets due to, for example, the limitations posed by the traditional entitlement provision methods.

### SUMMARY OF INVENTION

The present invention, which may be implemented utilizing a general-purpose digital computer, in certain embodiments of the present invention, includes novel methods and apparatus to provide efficient, effective, and/or flexible management of asset entitlement. In accordance with an embodiment of the present invention, a method of decoupling an entitlement creation from an asset attachment is disclosed. The method includes: upon a purchase of an entitlement, generating an entitlement entity corresponding to the purchased entitlement; generating an association entity corresponding to the entitlement entity; upon receiving an administrative request to associate the entitlement with an asset, generating an asset entity corresponding to the asset; and associating the asset entity with the entitlement entity.

In a further embodiment of the present invention, the method further includes setting an association entity state ID property to an attached state upon receiving the administrative request.

In another embodiment of the present invention, the method further includes applying a business rule to determine whether the administrative request is to be fulfilled.

In yet another embodiment of the present invention, the method additionally includes acknowledging at least one act selected from a group comprising the entitlement entity generation, the association entity generation, the asset entity generation, and the asset-entitlement entity association.

In a different embodiment of the present invention, a computer system for decoupling an entitlement creation from an asset attachment is disclosed. The computer system includes: a user environment to provide access to an entitlement; an entitlement system environment coupled to the user environment to generate an entitlement entity and an association entity, the entitlement entity corresponding to the entitlement, the association entity corresponding to the entitlement entity; and a feature system environment coupled to the entitlement system environment, the feature system environment receiving an administrative request to associate the entitlement with an asset, the feature system environment communicating with the entitlement system environment to generate an asset entity corresponding to the asset to facilitate association of the asset entity with the entitlement entity.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which certain embodiments of the present invention may be implemented;

FIG. 2 illustrates an exemplary system 200 in accordance with an embodiment of the present invention;

FIG. 3A illustrates an exemplary entitlement state diagram 300 in accordance with an embodiment of the present invention;

FIG. 3B illustrates an exemplary association state diagram 350 in accordance with an embodiment of the present invention; and

FIG. 4 illustrates an exemplary flow diagram of a method 400 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances: of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Before describing an exemplary environment in which various embodiments of the present invention may be implemented, some terms that will be used throughout this patent application will briefly be defined:

As used herein, “feature” means a mechanism accessed by a user to obtain benefits such as a service (e.g. a web-based application).

As used herein, “asset” means a computer system, server, a piece of software, a site, or a virtual location (such as a subnet).

As used herein, “entitled” means the right to benefit from a product, service, or experience. In an embodiment of the present invention, qualifiers may apply in order to be entitled, that is, only particular tangible or intangible asset(s) or particular contacts, people, or organizations might be entitled.

As used herein, “entitlement” means the way one may determine whether a user is entitled, such as through data stored in a system which may be used to allow a user to receive access to benefits such as products or services.

As used herein, “service entitlement” means data stored in a system which may be used to allow a user to receive service(s).

As used herein, “association” means a tie between the entitlement and the asset.

As used herein, “incident” generally means an entitlement with limited consumption. In an embodiment of the present invention, an incident has limited consumption, and optionally may have a specified period of time associated with it.

As used herein, “consumption” means usage of an entitlement.

As used herein, “subscription” generally means an entitlement with unlimited consumption. In an embodiment of the present invention, a subscription has a specified period of time, and optionally may have a limited consumption associated with it.

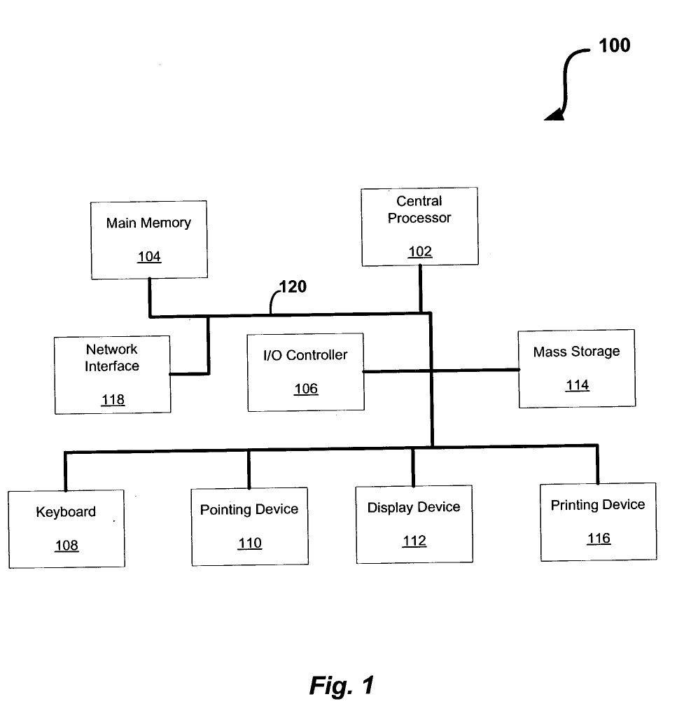

FIG. 1 illustrates an exemplary computer system 100 in which certain embodiments of the present invention may be implemented. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In accordance with an embodiment of the present invention, the computer system 100 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments of the present invention, the network interface 118 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 100 is a general purpose computer capable of running any number of applications such as those available from companies including Oracle, Siebel, Unisys, Microsoft, and the like.

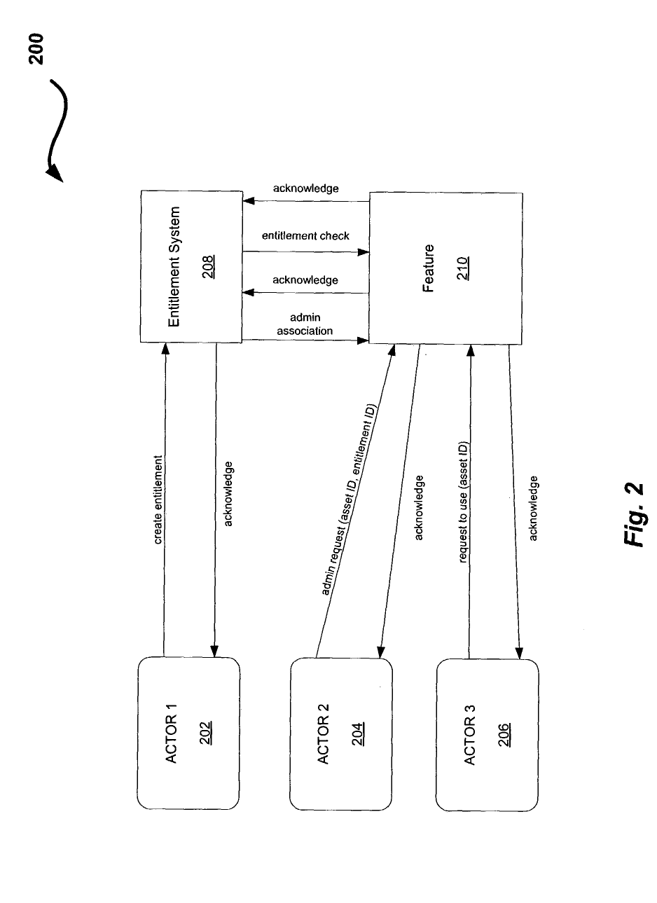

FIG. 2 illustrates an exemplary system 200 in accordance with an embodiment of the present invention. In an embodiment of the present invention, the system 200 includes three actors (202-206) and two systems (208 and 210). In one embodiment of the present invention, the actor 202 may be a person who purchases a product, the actor 204 may be a person who administers the purchased entitlement to a product, and the actor 206 may be a person who uses the product entitlements.

In a further embodiment of the present invention, the actors (202-206) may be systems acting as agents. For example, the actor 202 may be an electronic commerce (e-commerce) web application that has sold a product to an end user and needs to record the creation of that entitlement. In an alternate embodiment of the present invention, the actor 202 may be a software application that employees use to record entitlements sold by a manual process (e.g., telephone, fax, mail, and the like). Examples of the actor 204 include a web application that allows end-user association administration capabilities and/or a software application that permits employees to administer associations. Examples of the actor 206 include a web application directly used by end users or employees. It is envisioned that the end users in the above examples do not have to be the same end users. In accordance with an embodiment of the present invention, the separation of creation and administration of associations discussed herein is envisioned to be of value for such class of users.

As illustrated in FIG. 2, the actor 202 (which may be a system or process in an embodiment of the present invention) may request creation of an entitlement from the entitlement system 208. In one embodiment of the present invention, the entitlement system 208 and/or feature 210 may be implemented utilizing a computer system such as the computer system 100 of FIG. 1. The entitlement system 208 may acknowledge the entitlement creation request to the actor 202. The actor 204 may issue an administration request to the feature 210 (through for example providing an asset ID and/or an entitlement ID). The feature 210 may then acknowledge the administration request back to the actor 204. In an embodiment of the present invention, the administration request may be an attach request (e.g., to attach the entitlement to an asset), a remove request (e.g., to remove an established association), and/or replace request (e.g., to replace an attached asset association with a different asset association). The actor 206 may issue a request to use an entitlement associated with an asset to the feature 210 (through for example providing an asset ID). The feature 210 may then acknowledge the use request to the actor 206.

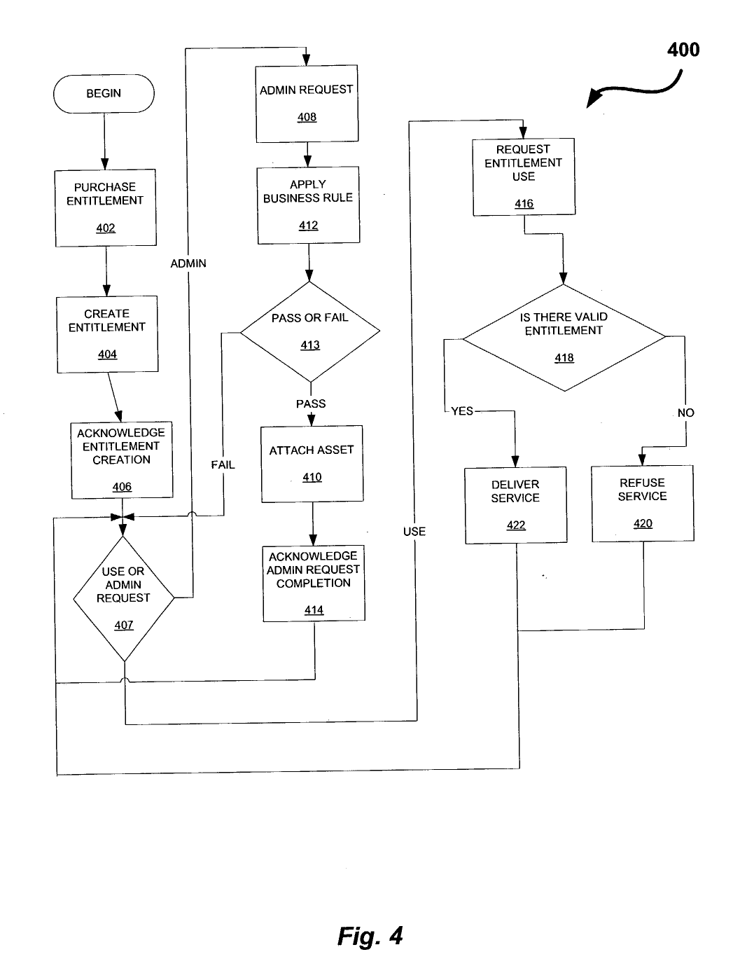

The entitlement system 208 and the feature 210 further communicate with each other to perform one or more of the following tasks as illustrated by FIG. 2: handling administrative requests initiated by the actor 204 (together with an acknowledgement) and/or checking the entitlement validity with respect to the use request initiated by the actor 206 (together with an acknowledgement). This interaction is further discussed with reference to FIG. 4.

The following defines the entities (i.e., entitlements, association, and asset) and their properties in accordance with various embodiments of the present invention:

Entitlement: an entitlement may have the following properties:

ID, such as an integer, internal identity (I)) (which may be hidden from users in an embodiment), and the like for the entitlement;

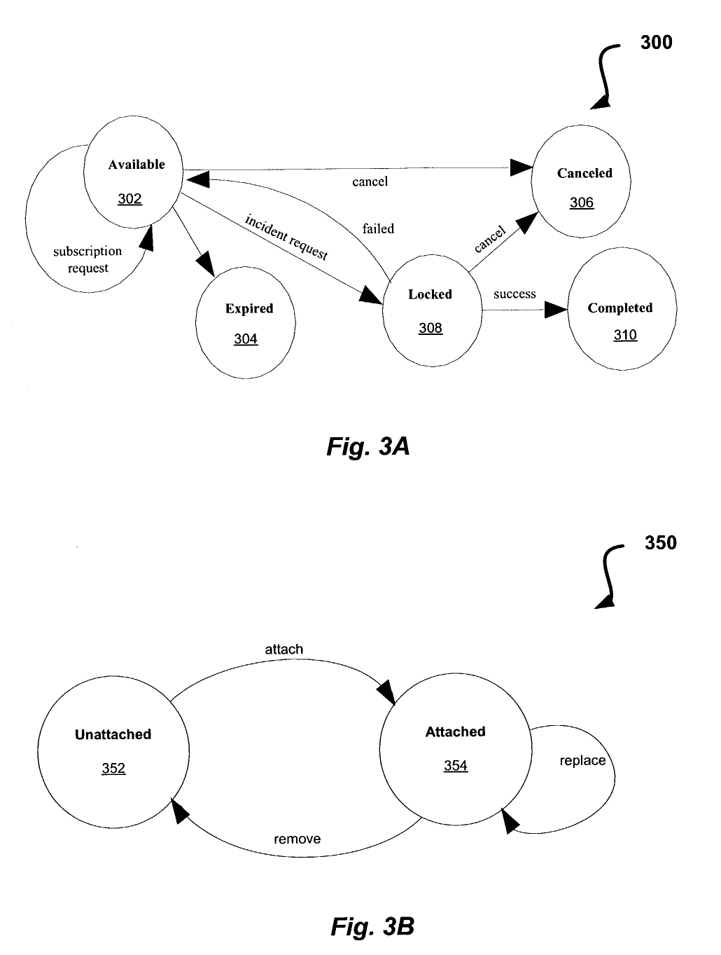

STATE, such as those discussed with respect to FIG. 3A;

TYPE, such as a subscription or incident;

QUANTITY, such as the number of entitlements for an incident type or for subscription tracking purposes;

DURATION, such as an expiration associated with the entitlement;

ASSOCIATION ID which identifies the corresponding association;

PRODUCT NAME which identifies the name of the product associated with the entitlement;

Association: an association may have the following properties:

ID, such as an integer, internal identity (ID) (which may be hidden from users in an embodiment), and the like for the association;

STATE, such as those discussed with respect to FIG. 3B;

ENTITLEMENT ID, such as an ID for the associated entitlement;

ASSET ID, such as an ID for the associated asset;

Asset: an asset or asset group may have the following properties:

ID, such as an integer, internal identity (ID) (which may be hidden from users in an embodiment), and the like for the asset;

TYPE, such as a software, serial number, site, and the like; and

ASSET NAME which may identify the name of the asset such as host name, location, and the like;

other ID, to identify other related assets (for example, for a site, the present asset may represent many corresponding assets which may be outside of the entitlement service in an embodiment of the present invention) or asset identifiers (for example, name, hostid, hostname, serial number, and the like in accordance with other embodiments of the present invention).

In one embodiment of the present invention, for each entitlement there may be 0 or 1 association to a particular asset. An association of 0 exists in the unattached state as will be discussed further with reference to FIG. 3A. In a further embodiment of the present invention, an entitlement may have many associations to many assets. Each association may have 0 or 1 asset. In an alternate embodiment of the present invention, there may be many entitlements attached to the same asset, but each association may at most have one corresponding entitlement and one corresponding asset. In a further embodiment of the present invention, the association entity may be internal to the system (i.e., hidden from users). In yet another embodiment of the present invention, it is envisioned that absence of an asset ID indicates that the entitlement is unattached (as will be discussed further with reference to FIG. 3B).

FIG. 3A illustrates an exemplary entitlement state diagram 300 in accordance with an embodiment of the present invention. In accordance with one embodiment of the present invention, the entitlement state diagram 300 provides the system states for an entitlement. The diagram 300 represents incident and subscription entitlements within one exemplary model. There are five states for an entitlement including: Available 302, Expired 304, Canceled 306, Locked 308, and Completed 310. The Available state 302 is the default state for an entitlement. The Available state 302 represents an active or otherwise usable entitlement. The Canceled state 306 represents a non-usable entitlement that is due to, for example, security fraud or consumer refund requested. The Expired state 304 represents a subscription or incident entitlement that has past its expiration. The Locked state 308 represents entitlements when the request to consume has been received but not yet fulfilled. The Completed state 310 represents an incident entitlement that has been successfully fulfilled.

Table 1 below provides an exemplary summary of the transitions between the states of FIG. 3A and the corresponding triggering events in accordance with an embodiment of the present invention.

TABLE 1
Entitlement States

| Entitlement State | Transition to . . . | Trigger |
|---|---|---|
| Available | Available | A consumption of a |
| | | subscription is required |
| | Canceled | Entitlement canceled (e.g., |
| | | via a tool) |
| | Locked | A consumption of an |
| | | Incident is requested |
| | Expired | Entitlement is no longer |
| | | usable |
| Locked | Canceled | Entitlement canceled (e.g., |
| | | via a tool) |
| | Completed | Incident consumption |
| | | occurred |
| | Available | Incident consumption failed |

For the transition from the Available state 302 to the Canceled state 306, a consumer request may have been made for a refund. Hence, the entitlement(s) will be removed and the consumer will receive a refund or service credit. On the expiration date, entitlements in the Available state 302 move to the Expired state 304. Accordingly, the subscription or incident entitlement will expire and will no longer be usable.

In accordance with an embodiment of the present invention, each entitlement may have an expiration date associated with it upon creation. When consumption for a subscription occurs, the entitlement moves from the Available state 302 to the Available state 302; thus, subscription entitlements are not used up and remain available until they expire or are canceled. In accordance with another embodiment of the present invention, subscription entitlements may have unlimited consumption, for example, for a specified period of time. For an incident entitlement request for consumption, entitlements transition from the Available state 302 to the Locked state 308; thus, once used, incident entitlements are no longer available.

In one embodiment of the present invention, incident entitlements may have limited consumption and/or a specified amount of time associated with them. When the consumption of an incident entitlement does not occur, the transition from the Locked state 308 to the Canceled state 306 may occur. When an incident entitlement is successfully consumed (i.e., the user is not entitled to use the entitlement anymore, even though the entitlement may still exist), the transition from the Locked state 308 to the Completed state 310 takes place. For the transition from the Locked state 308 to the Available state 302, the incident entitlement consumption request needs to fail to be fulfilled.

In a further embodiment of the present invention, each subscription or incident entitlement can be consumed. Because subscription entitlements may have unlimited consumption requests, they may never reach the Completed state 310. Therefore, each subscription entitlement may be available immediately after requesting consumption. Furthermore, when a request to consume an incident entitlement is made, it may no longer be available once consumption starts. In accordance with another embodiment of the present invention, incident entitlements may have a quantity of one associated with them that requires, for example, decrementing upon successful consumption or incrementing upon a need for providing a credit.

In accordance with yet another embodiment of the present invention, when a purchase is made for an incident or subscription-based product, entitlements may be created representative of the product purchased. For example, if a purchaser buys a support package, which contains five incidents, there will be five entitlements created, one for each incident purchased. If a purchaser buys a subscription to a service, then there may be one entitlement created for the service subscription. Business logic, on a case-by-case basis, may dictate from which state the entitlement will be generated. Although, entitlements are not necessarily dependent on a purchase in order to be created or otherwise to exist.

In a further embodiment of the present invention, entitlements may have one or more of the following characteristics: one or more entitlements can be created for each purchase; for each incident purchased, one entitlement may be created; for each subscription purchased, typically one entitlement may be created, although subscriptions could conceivably share an entitlement; and various rules can apply about what purchase states or other conditions trigger the creation of an entitlement.

FIG. 3B illustrates an exemplary association state diagram 350 in accordance with an embodiment of the present invention. In accordance with one embodiment of the present invention, the association state diagram 350 provides the system states for entitlement association. The diagram 350 includes the following two states for an association: Unattached 352 and Attached 354. The Unattached state 352 indicates that the asset remains unattached. The Attached state 354 indicates that the asset is attached.

Table 2 below provides an exemplary summary of the transitions between the states of FIG. 3B and the corresponding triggering events in accordance with an embodiment of the present invention.

TABLE 2
Association States

| Association State | Transition to . . . | Trigger |
|---|---|---|
| Unattached | Attached | attachment of an asset |
| Attached | Unattached | removal of an asset |
| | | association |
| | Attached | replacement of the attached |
| | | asset with another asset |

In an embodiment of the present invention, the removal of an asset association returns the association to the Unattached state 352 which will allow future association with a different asset.

FIG. 4 illustrates an exemplary flow diagram of a method 400 in accordance with an embodiment of the present invention. In an embodiment of the present invention, the method 400 illustrates the stages of entitlement management by decoupling the entitlement creation from asset attachment. The method 400 starts with a stage 402 to purchase an entitlement. In one embodiment of the present invention, the stage 402 may be performed through the actor 202 of FIG. 2. In a stage 404, the purchased entitlement is created. In an embodiment of the present invention, the entitlement may be created by the entitlement system 208 of FIG. 2. The entitlement may be created having one or more of the properties discussed herein. In one embodiment of the present invention, the entitlement creation also includes creating an association (e.g., having the properties discussed above). The association created may remain unattached at this stage (such as discussed with respect to FIG. 3B). In a stage 406, the creation of the entitlement is acknowledged (e.g., together with an entitlement ID). In one embodiment of the present invention, the acknowledgement is communicated to the entity initiating the stage 402.

In a stage 407, it is determined whether an administrative or use request is initiated. If it is determined that an administrative request is initiated, the method 400 continues with a stage 408 in which the processing of the administration request is initiated. In an embodiment of the present invention, the administration request may be an attach request (e.g., to attach the entitlement to an asset), a remove request (e.g., to remove an established association), and/or replace request (e.g., to replace an attached asset association with a different asset association). In a further embodiment of the present invention, the stage 408 triggers transition between association states such as those discussed with respect to FIG. 3B. In another embodiment of the present invention, the administration request may be accompanied by information including an asset ID, entitlement ID, or the like).

In one embodiment of the present invention, the stages 402, 404, and/or 408 may be performed at different times. A stage 412 applies any present business rules. The business rules may include permissions to use the entitlement, the state of the entitlement, the state of the association, and/or the age of the association. For example, there may be a business rule that only allows users to change the asset associated with an entitlement once every thirty days to avoid abuse.

A stage 413 determines the result of applying the business rule of the stage 412. If the business rule is successfully applies (i.e., a “pass” result), the method 400 continues with a stage 410 in which an asset is attached to the entitlement, for example, by utilizing the properties identified above. In a stage 414, the completion of the administration request initiated in the stage 408 is acknowledged and the method 400 returns to the stage 407 for further processing. In one embodiment of the present invention, the acknowledgement is communicated to the entity initiating the stage 408. If the stage 413 determines a failure associated with applying the business rule of the stage 412, the method 400 returns to the stage 407 for further processing.

If the stage 407 determines that a use request has been initiated, a stage 416 requests use of the entitlement for an asset. A stage 418 verifies whether a valid entitlement exists for the given asset (or whether the entitlement at issue has even been attached to the given asset) such as discussed with reference to the FIG. 2 (e.g., by communicating the asset ID to the entitlement system 208). If a valid entitlement does not exist, a stage 420 refuses the requested service. Otherwise, if a valid entitlement exists, a stage 422 delivers the service. The method 400 returns to the stage 407 after completing either the stages 420 or 422. In one embodiment of the present invention, the stages 402, 408, and 416 may be initiated by different entities or users.

In accordance with an embodiment of the present invention, a technique for decoupling entitlement creation from asset attachment is disclosed. The entitlement may be created without the association with an asset. This may apply to the class of entitlements that are associated with an asset such as warranty service or replacement on a computer system. For example, user 1 logs into a website and purchases a subscription. The entitlement created is then to be subsequently accessed, but before it is used (service is delivered) an asset must be attached to the subscription. Once the asset is attached, the service can then be used. In the above example, user 2 can go to the website, see that they have an “unattached” subscription, and perform the attachment process. It is envisioned that authentication for access to the entitlement may be passed between users through one or more of the following: Email, telephone transmission, voicemail, written note, web confirmation page, periodic publications, spoken words, fax transmission, and the like. Other actions that user 2 may perform include removing and replacing an association to an asset from an existing service entitlement. For entitlements with associated assets, a user 3 may use the entitlement to receive the service.

In a further embodiment of the present invention, rules may be established for the frequency and/or total number of such actions, for example, only allowing changes to be made once per month. The purpose of such rules would be for the system to flag or limit potential abuse.

In yet another embodiment of the present invention, the purchase process is separated from the consumption process. User 1 can purchase an entitlement without having to know the details of the related asset. User 2 can administer entitlements and user 3 can use them, without either having to be involved in the purchase of the entitlement. User 2 simply has to request that user 1 (such as a buyer for a company) needs to acquire n entitlements for m assets, but user 1 does not have to provide the exact list of assets.

The foregoing description has been directed to specific embodiments of the present invention. It will be apparent to those with ordinary skill in the art that modifications may be made to the described embodiments of the present invention, with the attainment of all or some of the advantages. For example, the techniques of the present invention may be utilized for provision of discounts (such as coupons, vouchers, and the like), royalty points, frequent shopping credit, and the like. Therefore, it is the object of the appended claims to cover all such variations and modifications as come within the spirit and scope of the invention.

What is claimed is:

1. A method of decoupling an entitlement creation from an asset attachment, the method comprising:
upon a purchase of an entitlement, generating an entitlement entity corresponding to the purchased entitlement;
generating an association entity corresponding to the entitlement entity;
upon receiving an administrative request to associate the entitlement with an asset, generating an asset entity corresponding to the asset; and
associating the asset entity with the entitlement entity.

2. The method of claim 1 wherein the association entity includes a state ID property initialized to an unattached state.

3. The method of claim 2 further including setting the association entity state ID property to an attached state upon receiving the administrative request.

4. The method of claim 1 wherein the entitlement entity includes one or more properties selected from a group comprising an entitlement ID and an association ID.

5. The method of claim 4 wherein the administrative request includes information selected from a group comprising the asset ID property and the entitlement ID property.

6. The method of claim 1 wherein the associating act is performed by corresponding an asset ID property of the association entity to the asset entity.

7. The method of claim 1 wherein the administrative request is selected from a group comprising attaching an asset, replacing an asset association, and removing an asset association.

8. The method of claim 1 further including applying a business rule to determine whether the administrative request is to be fulfilled.

9. The method of claim 1 further including acknowledging at least one act selected from a group comprising the entitlement entity generation, the association entity generation, the asset entity generation, and the asset-entitlement entity association.

10. The method of claim 1 wherein the entitlement entity corresponds to an item selected from a group comprising a warranty service and a computer replacement service.

11. The method of claim 1 wherein an authentication to access the entitlement is passed between a plurality of users by a method selected from a group comprising Email, telephone transmission, voicemail, written note, web confirmation page, periodic publications, spoken words, and fax transmission.

12. A computer system for decoupling an entitlement creation from an asset attachment, the computer system comprising:
a user environment to provide access to an entitlement;
an entitlement system environment coupled to the user environment to generate an entitlement entity and an association entity, the entitlement entity corresponding to the entitlement, the association entity corresponding to the entitlement entity; and
a feature system environment coupled to the entitlement system environment, the feature system environment receiving an administrative request to associate the entitlement with an asset, the feature system environment communicating with the entitlement system environment to generate an asset entity corresponding to the asset to facilitate association of the asset entity with the entitlement entity.

13. The computer system of claim 12 wherein the association entity includes a state ID property initialized to an unattached state.

14. The computer system of claim 12 wherein the entitlement entity includes one or more properties selected from a group comprising an entitlement ID and an association ID.

15. The computer system of claim 12 wherein the administrative request includes information selected from a group comprising the asset ID property and the entitlement ID property.

16. The computer system of claim 12 wherein the administrative request is selected from a group comprising attaching an asset, replacing an asset association, and removing an asset association.

17. The computer system of claim 12 further including a business rule facility to apply a business rule, wherein the business rule facility determines whether the administrative request is to be fulfilled.

18. The computer system facility of claim 12 further including an acknowledgment facility to acknowledge at least one act selected from a group comprising the entitlement entity generation, the association entity generation, the asset entity generation, and the asset-entitlement entity association.

19. The computer system of claim 12 wherein one or more of the user environment, the entitlement system environment, and the feature system environment communicate via a communication channel selected from a group comprising Ethernet, Fast Ethernet, WAN, leased line, analog modem, digital subscriber line, integrated services digital network DSL (IDSL), cellular, wireless network, time division multiplexing (TDM), universal serial bus, asynchronous transfer mode (ATM), satellite, cable modem, and FireWire.

20. The computer system of claim 19 wherein the leased line is selected from a group comprising T1, T3, and optical carrier 3 (OC3).

21. The computer system of claim 12 wherein one or more of the user environment, the entitlement system environment, and the feature system environment are implemented on a computer device running an operating system selected from a group comprising Solaris, Windows, HIP-UX, IBM-AIX, PALM, UNIX, Berkeley software distribution (BSD) UNIX, Linux, Apple UNIX (AUX), and Macintosh operating system (Mac OS).

22. An apparatus for decoupling an entitlement creation from an asset attachment, the apparatus comprising:
user means for providing access to an entitlement;
entitlement system means for generating an entitlement entity and an association entity, the entitlement entity corresponding to the entitlement, the association entity corresponding to the entitlement entity; and
feature system means coupled to the entitlement system means, the feature system means receiving an administrative request to associate the entitlement with an asset, the feature system means communicating with the entitlement system means for generating an asset entity corresponding to the asset.

23. The apparatus of claim 22 further including business rule means for applying a business rule, wherein the business rule means determines whether the administrative request is to be fulfilled.

24. An article of manufacture for decoupling an entitlement creation from an asset attachment, the article comprising:
a machine readable medium that provides instructions that, if executed by a machine, will cause the machine to perform operations including:
upon a purchase of an entitlement, generating an entitlement entity corresponding to the purchased entitlement;
generating an association entity corresponding to the entitlement entity;
upon receiving an administrative request to associate the entitlement with an asset, generating an asset entity corresponding to the asset; and
associating the asset entity with the entitlement. entity.

25. The article of claim 24 wherein the operations further include applying a business rule to determine whether the administrative request is to be fulfilled.

26. The article of claim 24 wherein the operations further include acknowledging at least one act selected from a group comprising the entitlement entity generation, the association entity generation, the asset entity generation, and the asset-entitlement entity association.
